(19) United States
(12) Patent Application Publication
(10) Pub. No.: US 2015/0055866 A1
(43) Pub. Date: Feb. 26, 2015

(54) OPTICAL CHARACTER RECOGNITION BY ITERATIVE RE-SEGMENTATION OF TEXT IMAGES USING HIGH-LEVEL CUES

(71) Applicants: Mark Joseph Cummins, Santa Monica, CA (US); Alessandro Bissacco, Los Angeles, CA (US)

(72) Inventors: Mark Joseph Cummins, Santa Monica, CA (US); Alessandro Bissacco, Los Angeles, CA (US)

(21) Appl. No.: 13/480,728

(22) Filed: May 25, 2012

(51) Int. Cl. G06K 9/34

(52) U.S. Cl. 382/176

(57) ABSTRACT

Disclosed techniques include receiving an electronic image containing depictions of characters, segmenting at least some of the depictions of characters using a first segmentation technique to produce a first segmented portion, and performing a first character recognition on the first segmented portion to determine a first sequence of characters. The techniques also include determining, based on the performing the first character recognition, that the first sequence of characters does not match the depictions of characters. The techniques further include segmenting at least some of the depictions of characters using a second segmentation technique, based on the determining, to produce a second segmented portion, and performing a second character recognition on at least a portion of the second segmented portion to produce a second sequence of characters. The techniques also include outputting a third sequence of characters based on at least part of the second sequence of characters.

### BACKGROUND

This disclosure relates to systems for, and methods of, optical character recognition.

Known techniques for optical character recognition (OCR) input an electronic document containing depictions of characters and output the characters in computer readable form. Such techniques can include sequentially staged processing, with stages such as text detection, line detection, character segmentation and character recognition.

### SUMMARY

Disclosed methods include receiving an electronic image containing depictions of characters, segmenting at least some of the depictions of characters using a first segmentation technique to produce a first segmented portion of the image, and performing a first character recognition on the first segmented portion of the image to determine a first sequence of characters. The methods also include determining, based on the performing the first character recognition, that the first sequence of characters does not match the depictions of characters. The methods further include segmenting at least some of the depictions of characters using a second segmentation technique, based on the determining, to produce a second segmented portion of the image, and performing a second character recognition on at least a portion of the second segmented portion of the image to produce a second sequence of characters. The methods also include outputting a third sequence of characters based on at least part of the second sequence of characters.

The above implementations can optionally include one or more of the following. Prior to the step of outputting, the methods can include determining, based on a prior character recognition, that a current sequence of characters does not match the depictions of characters, re-segmenting at least some of the depictions of characters, based on the determining that a current sequence of characters does not match the depictions of characters, to produce a re-segmented portion of the image, and performing another character recognition on at least a portion of the re-segmented portion of the image to produce another sequence of characters. The aforementioned steps can be iterated until a predetermined condition is reached. The predetermined condition can include at least one of: reaching a predetermined number of iterations, reaching a predetermined time limit, and reaching a stable third sequence of characters. The first segmentation technique can include at least one of detecting connected components and the use of a sliding window classifier. The second segmentation technique can include at least one of detecting connected components and the use of a sliding window classifier. The performing the first character recognition can include usage of at least one of a language model and a model for relative sizes of adjacent characters. The performing the second character recognition can include usage of at least one of a language model and a model for relative sizes of adjacent characters. The determining can include identifying a location in the image at which the first sequence of characters potentially does not match the depictions of characters. The outputting can include storing in persistent memory.

Disclosed systems include at least one processor configured to segment at least some depictions of characters, in an electronic image containing depictions of characters, using a first segmentation technique to produce a first segmented portion of the image, and at least one processor configured to perform a first character recognition on the segmented portion of the image to determine a first sequence of characters. The systems also include at least one processor configured to determine, based on the first character recognition, that the first sequence of characters does not match the depictions of characters. The systems further include at least one processor configured to segment at least some of the depictions of characters using a second segmentation technique, based on the determination that the first sequence of characters does not match the depiction of characters, to produce a second segmented portion of the image. The disclosed systems further include at least one processor configured to perform a second character recognition on at least a portion of the second segmented portion of the image, to produce a second sequence of characters. The disclosed systems further include at least one processor configured to output a third sequence of characters based on at least part of the second sequence of characters.

The above implementations can optionally include one or more of the following. The systems can include at least one processor configured to determine, based on a prior character recognition, that a current sequence of characters does not match the depictions of characters, at least one processor configured to re-segment at least some of the depictions of characters, based on the determination that the current sequence of characters does not match the depiction of characters, that a current sequence of characters does not match the depictions of characters, to produce a re-segmented portion of the image, and at least one processor configured to perform another character recognition on at least a portion of the re-segmented portion of the image to produce another sequence of characters. The systems can include at least one processor configured to iterate determining that the current sequence of characters does not match the depictions of characters, re-segmenting the at least some depictions, and performing the another character recognition, until a predetermined condition is reached. The predetermined condition can include at least one of: reaching a predetermined number of iterations, reaching a predetermined time limit, and reaching a stable third sequence of characters. The first segmentation technique can include at least one of detecting connected components and use of a sliding window classifier. The second segmentation technique can include at least one of detecting connected components and use of a sliding window classifier. The at least one processor configured to perform the first character recognition can be further configured to use of at least one of a language model and a model for relative sizes of adjacent characters. The at least one processor configured to perform the second character recognition can be further configured to use of at least one of a language model and a model for relative sizes of adjacent characters. The at least one processor configured to determine that the current sequence of characters does not match the depictions of characters can be further configured to identify a location in the image at which the first sequence of characters potentially does not match the depictions of characters.

Disclosed products of manufacture include processor-readable media storing code representing instructions that, when executed by at least one processor, cause the at least one processor to perform an optical character recognition for an electronic image containing depictions of characters by performing the following: segmenting at least some of the depictions of characters using a first segmentation technique to produce a segmented portion of the image, performing a first character recognition on the segmented portion of the image to determine a first sequence of characters, determining, based on the performing the first character recognition, that the first sequence of characters does not match the depictions of characters, segmenting at least some of the depictions of characters using a second segmentation technique, based on the determining to produce a second segmented portion of the image, performing a second character recognition on at least a portion of the second segmented portion of the image to produce a second sequence of characters, and outputting a third sequence of characters based on at least part of the second sequence of characters.

Techniques disclosed herein include certain technical advantages. Some implementations are capable of performing staged optical character recognition using information fed back from later stages to earlier stages. Such implementations provide more accurate character recognition, thus achieving a technical advantage.

### DESCRIPTION OF DRAWINGS

The accompanying drawings, which are incorporated in and constitute a part of this specification, illustrate implementations of the disclosed technology and together with the description, serve to explain the principles of the disclosed technology. In the figures:

FIG. 1 is a schematic diagram of a system according to some implementations;

FIG. 2 is a schematic representation of iterative segmentation according to some implementations;

FIG. 3 is a flowchart of a method according to some implementations; and

FIG. 4 is a schematic depiction of a particular segmentation technique according to some implementations.

### DETAILED DESCRIPTION

Conventional OCR techniques accept as an input an electronic document containing depictions of characters, and output the characters in computer readable form, e.g., Unicode or ASCII. Such techniques can include staged processing, with stages such as text detection, line detection, character segmentation and character recognition. Errors incurred at earlier stages can propagate to later stages, compounding the errors. Some implementations feed information from later stages back to earlier stages, thus reducing errors and producing more accurate character recognition.

Reference will now be made in detail to example implementations, which are illustrated in the accompanying drawings. Where possible the same reference numbers will be used throughout the drawings to refer to the same or like parts.

In general, optical character recognition (OCR) techniques accept an electronic image containing depictions of text as an input, and output the text in machine-readable form, e.g., ASCII. The electronic images used as inputs can be created using a camera, a scanner, or any other device that captures an electronic image of a physical thing. Alternately, or in addition, electronic images can be completely or partially computer generated. Electronic images can be retrieved from persistent or transient memory, or received from a third party, e.g., over a network such as the internet.

In general, conventional OCR includes several stages. Such stages can include text detection, line detection, character segmentation and character recognition. Text detection generally refers to identifying regions in an image that contain possible text, and line detection generally refers to identifying an orientation of, and/or generating a bounding box for, possible text in an image. Character segmentation and character recognition are described in detail below.

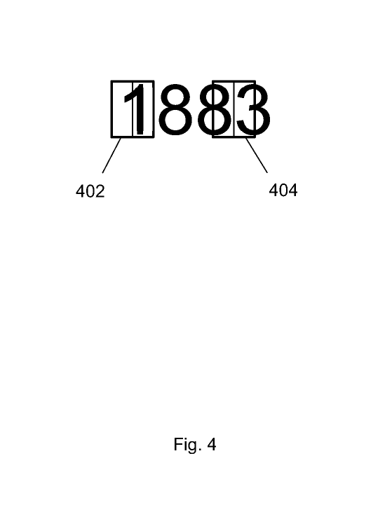

Character segmentation generally refers to breaking up an image containing character depictions into discrete regions, where each region is intended to enclose a single character. Character segmentation can allow a portion of character to extend beyond the corresponding demarcated region. Example character segmentation techniques include detecting connected components and the use of a sliding window classifier. An example sliding window classifier character segmentation technique is described in detail below in reference to FIG. 4.

Character segmentation can treat typographic ligatures, e.g., glyphs made up of multiple graphemes, as single characters for segmentation purposes. A “grapheme” is a minimal unit in a writing system. Typographic ligatures include special characters consisting of multiple graphemes for, by way of non-limiting example, the letter combinations “fi”, “ff” and “fl”. Furthermore, some character segmentation techniques segment at the bigram, trigram or word level. A “bigram” is a sequence of two characters, e.g., “at”, “ae” and “th”, and a “trigram” is a sequence of three characters, e.g., “the”, “and” and “ver”. Accordingly, for the techniques described herein, the term “character” embraces single-grapheme characters, multiple-grapheme characters, typographic ligatures, bigrams, trigrams and single words.

Character recognition generally refers to the process of discerning computer-readable characters from segmented images. Character recognition techniques include, by way of non-limiting example, the use of a character classifier, the use of a language model, e.g., a function that accepts a string of text and a character as inputs and outputs a probability that the character would appear next in the string, and the use of a model for the relative sizes of adjacent characters.

OCR stages can run sequentially, typically with increasingly complex processing at each stage. For example, an OCR technique can include, in order, a single stage of each of: text detection, line detection, character segmentation and character recognition. For sequentially-run stages, however, errors at an earlier stage can propagate to later stages, compromising the accuracy of the ultimate output.

Some implementations reduce or eliminate the error propagation problem by repeating earlier stages with the benefit of high-level information obtained at later stages. In particular, some implementations feed high-level cues from the character recognition stage back to the character segmentation stage. Errors in segmentation can accordingly be corrected prior to outputting the ultimate computer readable text.

For example, an image includes a depiction of the text “the result”. After a first character segmentation and a first character recognition, the associated text is determined to be “the reslt”. However, information gleaned from the character recognition stage is used to infer that this is likely incorrect. In particular, a language model provides a very low probability of the character “I” following the string “res” in the second word in the example text. Based on this inference, some implementations re-segment the example text, focusing on the region of the potential error. The re-segmentation techniqueinitial can utilize a more sensitive, e.g., more likely to erroneously segment, or computationally expensive segmentation technique than that used for the first segmentation.

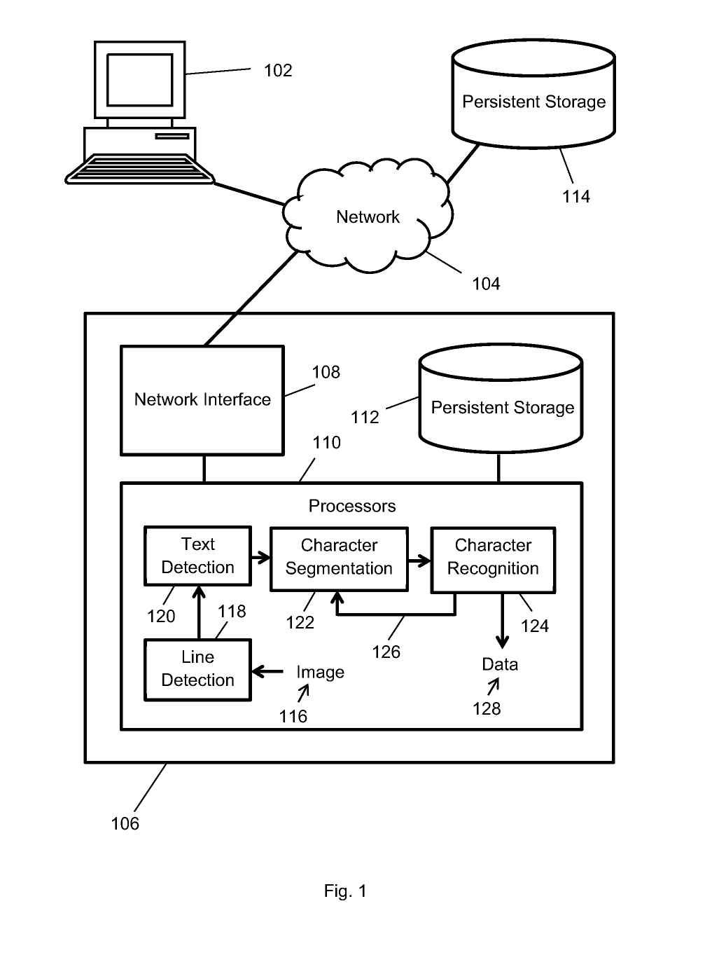

FIG. 1 is a schematic diagram of a system according to some implementations. In particular, FIG. 1 illustrates various hardware, software, and other resources that can be used in some implementations of OCR system 106. In some implementations as shown, OCR system 106 can include one or more processors 110 coupled to a random access memory operating under control of, or in conjunction with, an operating system. Processors 110 in some implementations can be incorporated in one or more servers, clusters, or other computers or hardware resources, or can be implemented using cloud-based resources. Processors 110 can communicate with persistent memory 112, such as a hard drive or drive array, to obtain or store images, text information, or both. Further, persistent memory 112 can contain and provide to processors 110 computer executable code, such as that configured to perform the techniques disclosed herein.

Processor 110 can further communicate with a network interface 108, such as an Ethernet or wireless data connection, which in turn can communicate with the one or more networks 104, such as the Internet or other public or private networks, through which an image can be received from client device 102, persistent storage 114, or other device or service. Client device 102 can be, e.g., a portable computer, a desktop computer, a tablet computer, or a mobile phone.

In operation, processors 110 perform method steps as follows. Processors 110 obtain image 116, on which processors 110 perform line detection 118 and then text detection 120. Subsequently, processors 110 perform character segmentation 122 and then character recognition 124. Processors 110 feed information from character recognition 124 back to character segmentation 122 so that segments can be adjusted. Once processors 110 reach a stopping condition, character recognition 124 outputs computer readable data 128 including text from image 116.

Other configurations of OCR system 106, associated storage devices and network connections, and other hardware, software, and service resources are possible.

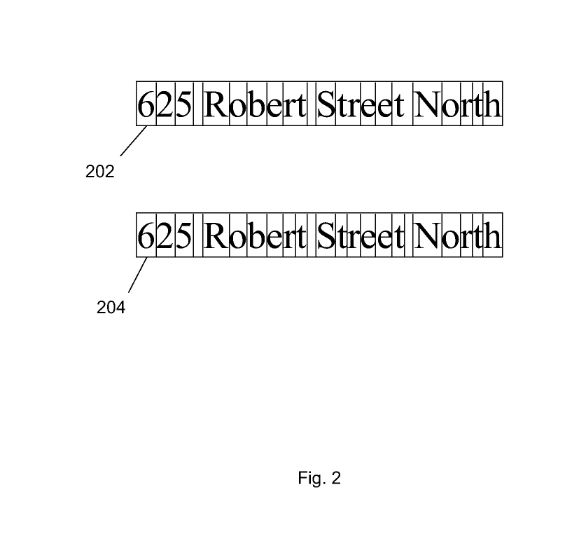

FIG. 2 is a schematic representation of iterative segmentation according to some implementations. In particular, segmentation 202 represents an example single segmentation attempt for the phrase “625 Robert Street North” appearing in an image. This single segmentation attempt includes erroneous segmentations at three places. In particular, the letters “rt” at the end of “Robert” have been recognized as only a single character. Furthermore, the characters “tr” in “street” have not been correctly segmented into two separate characters. Additionally, the letter “t” at the end of “Street” and the letter “N” at the beginning of “North” have not been correctly segmented to indicate the presence of a space. Thus, segmentation 202 represents a first attempt at segmenting a particular string, including three errors.

Applying a character recognition stage to the incorrect segmentation 202 will likely result in an incorrect recognition. Indeed, an example character recognition stage applied to segmentation 202 yields “625 Roben SmeetNorth”. This example illustrates error propagation from the segmentation stage to the character recognition stage.

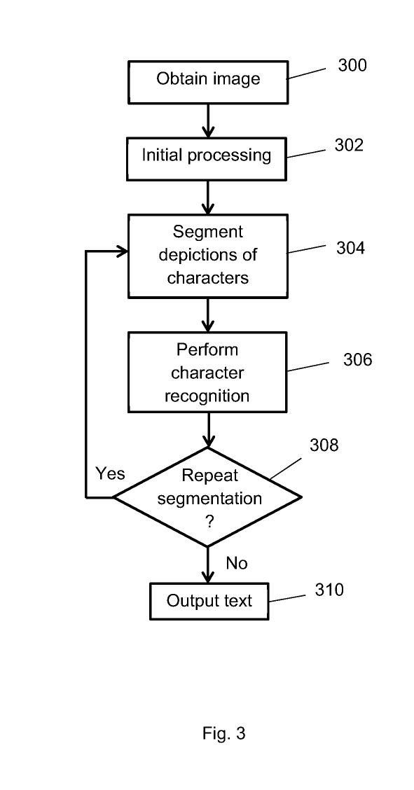

Segmentation 204, on the other hand, represents a segmentation of the same string, “625 Robert Street North”, after undergoing additional character recognition and segmentation stages. Thus, segmentation 204 is the result of segmentation 202 undergoing a character recognition stage and additional processing as described presently. As described above, applying a character recognition stage to segmentation 202 yields, by way of example, “625 Roben SmeetNorth”. However, a language model, which can be part of the character recognition stage, provides a very low probability of the letter “n” following the string “Robe”. A language model also determines a low probability of the letter “N” following the string “Smeet”. These low probabilities are used to identify locations in the string that should be re-segmented due to possible errors. A language model also determines a low probability of the character “m” appearing as it does in the string “Smeet”. Similarly, a model for the relative sizes of adjacent characters, which can be used as part of the character recognition stage, finds that the limited space apparently allotted to the junction between the potential words “Smeet” and “North” is unlikely. Accordingly, such a model identifies the region in the string that should undergo an additional segmentation. The re-segmentation can be more sensitive and/or computationally intensive. Furthermore, the re-segmentation, followed by another character recognition stage, yields the correct string, “625 Robert Street North”. The description regarding FIG. 3 below provides further elaboration of the process illustrated above in reference to FIG. 2.

FIG. 3 is a flowchart of a method according to some implementations. The method of FIG. 3 can be carried out entirely or partially by the system described above in reference to FIG. 1. At block 300 an electronic image is obtained. The image can be obtained by retrieving it from storage, e.g., data store 112 of FIG. 1. Alternately, or in addition, the image can be obtained from a third party, e.g., over a network, e.g., utilizing network interface 108 of FIG. 1. The image can be obtained by direct creation, e.g., by the use of an image capture device such as a digital camera or digital scanner. The image can be obtained by computer generation. Any of the aforementioned techniques can be combined. For example, a user can obtain an image from a third party, who created the image by capturing a digital photograph using a digital camera. The user can subsequently deposit the obtained image in persistent storage, e.g., persistent storage 112 of FIG. 1, for later retrieval according to block 300.

At block 302, initial processing can occur. Such initial processing can include, by way of non-limiting example, text detection and line detection. Text detection aims to locate areas of potential text in an image. Text detection techniques can rely on heuristics, e.g., searching for high gradient density areas, or machine learning, e.g., utilizing a support vector machine. Heuristic techniques first detect all edges in the image, then identify areas of high-density horizontally-aligned vertical edges, which indicate the presence of text. Machine learning techniques, e.g., linear classifiers, support vector machines or neural networks, train a processor using a corpus of images in which text has been identified to identify similar locations in other images.

Line detection aims to find an orientation and boundary of potential text. Line detection techniques can rely on geometric matching, e.g., least squares, to identify an orientation of a string of text appearing in an image. A virtual bounding box can be imposed so that the text can be further processed in an efficient manner that reduces interference by background and other imagery. For example, a later segmentation stage can be limited to analyzing the contents of the virtual bounding box.

The initial processing steps, e.g., text detection and line detection, represented in block 302 are optional and known.

At block 304, the depiction of characters appearing in the image are segmented. Various segmentation techniques are compatible with implementations. For example, detecting connected components can be used to segment text. Regions in the image that have a threshold brightness difference from an adjacent region can be considered characters in some implementations of the connected component approach. That is, isolated islands of pixels of similar brightness levels can be considered characters. As another example, edge detection can be used to segment characters, e.g., by locating adjacent vertical edges in a pattern indicative of characters. Machine learning techniques, such as a sliding window classifier implementing, for example, a support vector machine can be used to segment text. Some particular implementations according to this approach are described in detail below in reference to FIG. 4.

At block 306, the segmented characters are processed according to a character recognition technique. Character recognition can be performed, alone or in part, by character classifiers, such as those that utilize machine learning techniques. Example machine learning techniques can rely on the use of linear classifiers, support vector machines or neural networks. Alternately or in addition, character recognition techniques can utilize any, or a combination, of feature classifiers, contour classifiers, a language model, and a model for the relative sizes of adjacent characters.

In general, the character recognition technique of block 306 produces information indicative of an error. For example, a language model can estimate a low probability of a particular character depicted in the image as being the character initially recognized at block 306. As another example, a model of the relative size of adjacent characters can calculate a low probability of a particular recognized character occupying a particular space in the image, e.g., by noting a relative size discrepancy among a particular triple of characters. As another example, a low score from a character classifier can indicate a low probability of a particular recognized character occupying a particular space in the image, e.g., by attributing a low confidence to a particular classification. In any of the preceding examples, the information indicative of an error can have associated location information. That is, the character recognition technique of block 306 can produce data reflecting the location of a possible erroneous segmentation in the image.

At block 308, the technique makes a determination of whether to repeat the segmentation step of block 304, with a possible replacement, or modification, of the segmentation technique. Such a determination can be based on whether a possible error has been detected. The determination can take into account the probability of an error, and only make a positive determination if the probability rises to a predetermined level.

If the process of block 308 branches back to block 304, information regarding the error can also be passed back to the segmentation stage. This information can include location information regarding the error. In such cases, the segmentation can concentrate, or focus exclusively, on the passed location or locations.

The segmentation at block 304 that results from a branch back at block 308 can be of the same or different type from the original or previous segmentation of block 304. For example, for techniques that utilize detection of connected components, the first segmentation can utilize a first threshold of brightness difference, whereas subsequent segmentation techniques can utilize a second threshold of brightness difference, where the second threshold is less than the first. Subsequent segmentations can lower the brightness difference threshold further each time. For edge detection techniques, a similar threshold-lowering approach can be utilized. That is, an initial segmentation can require a first probability threshold to be exceeded before concluding that an edge is present, and subsequent segmentation techniques can rely on a second probability that is less than the first. Each subsequent segmentation can utilize a lower threshold. For implementations that utilize a support vector machine approach, subsequent segmentations can utilize lower confidence levels than previous segmentations.

Even if an error is present, the process cam branch to block 310 under certain conditions. For example, the process can branch to block 310 despite the presence of a possible error if a predetermined limit on the number of iterations has been reached, if a predetermined time limit has been reached, or if the recognized characters converge to a stable set. Other termination conditions can be utilized beyond the example conditions described in this paragraph.

At block 310, the process outputs the computer readable text resulting from the process described in reference to FIG. 3. The computer readable text can be in the form of, for example, ASCII, Unicode, ANSI, HTML, XML, etc. There are various different ways by which the process can output the computer readable text. In some implementations, the computer readable text is passed to a different process, e.g., a process that associates the text to the image. In some implementations, the computer readable text is output in human readable form, e.g., on a computer monitor. In some implementations, the computer readable text is output to a persistent or transient memory, e.g., persistent memory 112 or 114 of FIG. 1.

FIG. 4 is a schematic depiction of a particular segmentation technique according to some implementations. The technique of FIG. 4 can utilize any of a variety of machine learning techniques, e.g., linear classifiers, support vector machines or neural networks. Such techniques are capable of detecting whether a virtual window is centered on a breakpoint between characters 404, or not centered on a breakpoint between characters 402.

Machine learning techniques according to the technique of FIG. 4 can rely on a corpus of training data. In particular, the training data can include images containing depictions of text along with virtual square or rectangular windows imposed on the text, some centered at a breakpoint between characters, e.g., 404, and some not, e.g., 402. The training data further includes indications as to whether the window is so centered or not. The machine learning techniques suitable for implementations according to FIG. 4 process the training data and are subsequently capable of determining whether a virtual window is centered at a breakpoint between characters in an arbitrary image depicting text. That is, the machine learning techniques, once trained, are capable of providing either a binary determination, e.g., outputting “yes” or “no”, or a probabilistic determination, e.g., outputting a probability, of whether a particular virtual window is centered at a breakpoint between characters in a particular image containing text.

The machine learning approach to segmentation described above can be combined with segmentation using connected component detection. In such implementations, partitions between characters can come from the machine learning technique, the connected component technique, or both. That is, in some implementations, both the machine learning approach and the connected components approach contribute partitions between segments.

In general, systems capable of performing the presented techniques may take many different forms. Further, the functionality of one portion of the system may be substituted into another portion of the system. Each hardware component may include one or more processors coupled to random access memory operating under control of, or in conjunction with, an operating system. The system can include network interfaces to connect with clients through a network. Such interfaces can include one or more servers. Appropriate networks include the internet, as well as smaller networks such as wide area networks (WAN) and local area networks (LAN). Networks internal to businesses or enterprises are also contemplated Further, each hardware component can include persistent storage, such as a hard drive or drive array, which can store program instructions to perform the techniques presented herein. That is, such program instructions can serve to control OCR operations as presented. Other configurations of OCR system 106, associated network connections, and other hardware, software, and service resources are possible.

The foregoing description is illustrative, and variations in configuration and implementation are possible. For example, resources described as singular can be plural, and resources described as integrated can be distributed. Further, resources described as multiple or distributed can be combined. The scope of the presented techniques is accordingly intended to be limited only by the following claims.

1. A computer implemented method comprising:
receiving an electronic image containing depictions of characters;
segmenting at least some of the depictions of characters using a first segmentation technique to produce a first segmentation of the image, the first segmentation segmenting at least a portion of the image into a plurality of regions;
performing a first character recognition on the first segmentation of the image to determine a first sequence of characters;
determining, from the first sequence of characters, that one or more regions from the plurality of regions in the first segmentation include a possible segmentation error;
segmenting less than all of the plurality of regions in the first segmentation using a second segmentation technique to produce a second segmentation of the image, wherein segmenting less than all of the plurality of regions comprises segmenting the one or more regions that include a possible segmentation error;
performing a second character recognition on at least a portion of the second segmentation of the image to produce a second sequence of characters; and
outputting a third sequence of characters based on at least part of the second sequence of characters.

2. The method of claim 1, further comprising, prior to the step of outputting:
determining, from a current sequence of characters, that one or more regions in a current segmentation include a possible segmentation error;
re-segmenting at least the one or more regions in the current segmentation to produce a next segmentation; and
performing another character recognition on at least a portion of the next segmentation of the image to produce another sequence of characters.

3. The method of claim 2, further comprising iterating the steps of claim 2 until a predetermined condition is reached.

4. The method of claim 3, wherein the predetermined condition comprises at least one of: reaching a predetermined number of iterations, reaching a predetermined time limit, or reaching a stable third sequence of characters.

5. The method of claim 1, wherein the first segmentation technique comprises at least one of detecting connected components or use of a sliding window classifier.

6. The method of claim 1, wherein the second segmentation technique comprises at least one of detecting connected components or use of a sliding window classifier.

7. The method of claim 1, wherein the performing the first character recognition comprises usage of at least one of a language model or a model for relative sizes of adjacent characters.

8. The method of claim 1, wherein the performing the second character recognition comprises usage of at least one of a language model or a model for relative sizes of adjacent characters.

9. (canceled)

10. The method of claim 1, wherein the outputting comprises storing in persistent memory.

11. A system comprising:
at least one processor configured to:
segment at least some depictions of characters, in an electronic image containing depictions of characters, using a first segmentation technique to produce a first segmentation of the image, the first segmentation segmenting at least a portion of the image into a plurality of regions;
perform a first character recognition on the first segmentation of the image to determine a first sequence of characters;
determine, from the first sequence of characters that one or more regions from the plurality of regions in the first segmentation include a possible segmentation error;
segment less than all of the plurality of regions in the first segmentation using a second segmentation technique to produce a second segmentation of the image, wherein segmenting less than all of the plurality of regions comprises segmenting the one or more regions that include a possible segmentation error;
perform a second character recognition on at least a portion of the second segmentation of the image to produce a second sequence of characters; and
output a third sequence of characters based on at least part of the second sequence of characters.

12. The system of claim 11, wherein the at Least one processor is further configured to:
determine, from a current sequence of characters, that one or more regions in a current segmentation include a possible segmentation error;
re-segment at least the one or more regions in the current segmentation to produce a next segmentation of the image; and
perform another character recognition on at least a portion of the next segmentation of the image to produce another sequence of characters.

13. The system of claim 12, wherein the at least one process is further configured to:
iterate determining that the current sequence of characters does not match the depictions of characters, re-segmenting the at least some depictions, and performing the another character recognition, until a predetermined condition is reached.

14. The system of claim 13, wherein the predetermined condition comprises at least one of: reaching a predetermined number of iterations, reaching a predetermined time limit, or reaching a stable third sequence of characters.

15. The system of claim 11, wherein the first segmentation technique comprises at least one of detecting connected components or use of a sliding window classifier.

16. The system of claim 11, wherein the second segmentation technique comprises at least one of detecting connected components or use of a sliding window classifier.

17. The system of claim 11, wherein the at least one processor is further configured to:
use at least one of a language model or a model for relative sizes of adjacent characters to perform the first character recognition.

18. The system of claim 11, wherein the at least one processor further configured to:
use at least one of a language model or a model for relative sizes of adjacent characters to perform the second character recognition.

19. (canceled)

20. A non-transitory processor-readable medium storing code representing instructions that, when executed by at least one processor, cause the at least one processor to perform an optical character recognition for an electronic image containing depictions of characters by:
segmenting at least some of the depictions of characters using a first segmentation technique to produce a first segmentation of the image, the first segmentation segmenting at least a portion of the image into a plurality of regions;
performing a first character recognition on the first segmentation of the image to determine a first sequence of characters;
determining, from the first sequence of characters, that one or more regions from the plurality of regions in the first segmentation include a possible segmentation error;
segmenting less than all of the plurality of regions using a second segmentation technique to produce a second segmentation of the image, wherein segmenting less than all of the plurality of regions comprises segmenting the one or more regions that include a possible segmentation error;
performing a second character recognition on at least a portion of the second segmentation of the image to produce a second sequence of characters; and
outputting a third sequence of characters based on at least part of the second sequence of characters.
